(19) United States
(12) Patent Application Publication
(10) Pub. No.: US 2013/0155234 A1
(43) Pub. Date: Jun. 20, 2013

(54) Monitoring Device and the Method Thereof

(71) Applicant: TRANSPAC CORPORATION, TOKYO City (JP)

(72) Inventor: ENATSU IHO, TOKYO City (JP)

(73) Assignee: TRANSPAC CORPORATION, TOKYO City (JP)

(21) Appl. No.: 13/720,985

(22) Filed: Dec. 19, 2012

(30) Foreign Application Priority Data
Dec. 19, 2011 (TW) 100147158

(51) Int. Cl. H04N 7/18

(52) U.S. Cl. CPC H04N 7/18
USPC 348/143

(57) ABSTRACT

A monitoring device includes a commercial trading device and a camera device. The camera device is disposed on a first position of the commercial trading device. The camera device has a first view plane formed at one side of the commercial trading device and the normal of the first view plane is parallel to or intersects with the horizontal plane of the first position at an acute angle. A monitoring method includes: retrieving trading information of the commercial trading device and image information of the camera device, analyzing the image information in the storage unit and the image information presently captured by the camera device to produce a comparison result, adjusting the image information presently captured by the camera device to produce a corrected image, and receiving the comparison result and the corrected image by a display module. When the comparison result shows any abnormal event, the display module outputs a warning and the corrected image corresponding thereto.

### BACKGROUND OF THE INVENTION

1. Field of the Invention

The present invention relates to a monitoring device; particularly, the present invention relates to a monitoring device disposed on a cash register or in the vicinity of a checkout counter/cash desk for video and audio surveillance.

2. Description of the Prior Art

A cash desk/checkout counter is an important site in a business place where trivial works such as customer service and cash transaction frequently take place and thus is a high crime risk area. FIG. 1 is a schematic view of the traditional monitoring device when capturing images. As shown in FIG. 1, the current security measures adopt the disposition of a camera device at the rear corner above the cash desk to record images outwardly from the inner side of the cash desk. Because of the limited viewing angle, activities around the cash desk are recorded but face character cannot be clearly captured. Although the current fisheye photography technology can achieve the no-dead-zone effect, the face character is still not easy to be identified because the camera device is disposed on the ceiling and a depression angle is flat after the semi-sphere picture adjusted by the nonlinear correction process. The viewing angle and the clarity are lack of optimum arrangement.

Due to the limitation to video quality and viewing angle, the captured image is not suitable for computer program analysis on people shown in the image so that the monitoring system is merely for recordation and cannot actively alert or report abnormal events. Therefore, the early warning effect of the monitoring system is greatly diminished.

### SUMMARY OF THE INVENTION

It is an object of the present invention to provide a monitoring device that can clearly capture the front side of physical characteristics.

It is another object of the present invention to provide a monitoring device that can receive image information and actively alert for abnormal events.

A monitoring device includes a commercial trading device and a camera device. The camera device is disposed on a first position of the commercial trading device. The camera device has a first view plane formed at one side of the commercial trading device and the first view plane is parallel to or intersects with the horizontal plane of the first position at an acute angle.

A monitoring method includes: retrieving trading information of the commercial trading device and image information of the camera device, analyzing the image information to produce a comparison result, adjusting the image information to produce a corrected image, and receiving the comparison result and the corrected image by a display module. When the comparison result shows any abnormal event, the display module outputs a warning and the corrected image corresponding thereto.

### BRIEF DESCRIPTION OF THE DRAWINGS

FIG. 1 is a schematic view of the image captured by the traditional monitoring device;

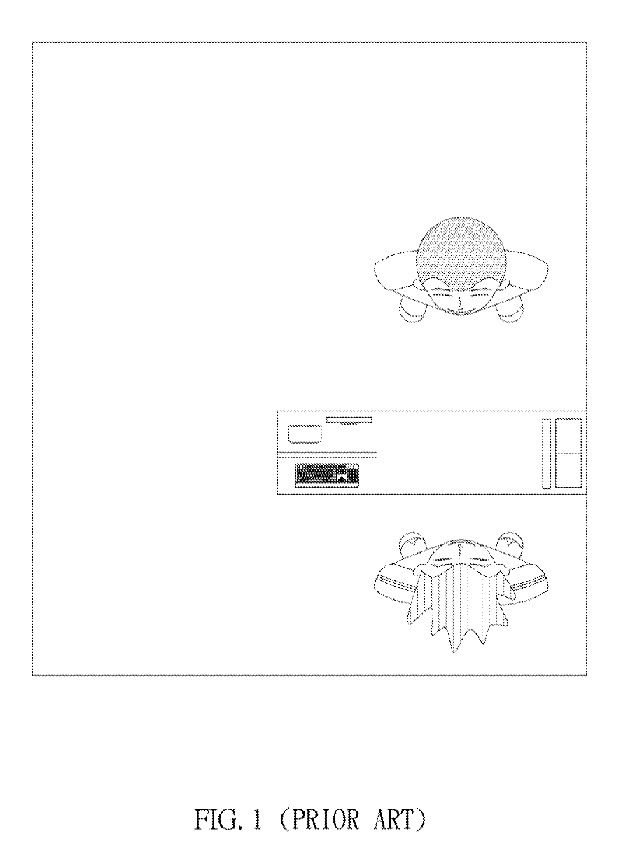

FIG. 2A is a side view of the monitoring device of the present invention;

FIG. 2B is a top view of the monitoring device of the present invention;

FIG. 3A is a schematic view of an embodiment of the monitoring device of the present invention;

FIG. 3B is a schematic view of the image captured by the monitoring device of the present invention;

FIG. 4A is a schematic view of another embodiment of the monitoring device of the present invention;

FIG. 4B is another schematic view of the image captured by the monitoring device of the present invention;

FIG. 5A is a schematic view of the monitoring device of the present invention;

FIG. 5B is a flow chart of the monitoring method of the present invention.

### DETAILED DESCRIPTION OF THE PREFERRED EMBODIMENT

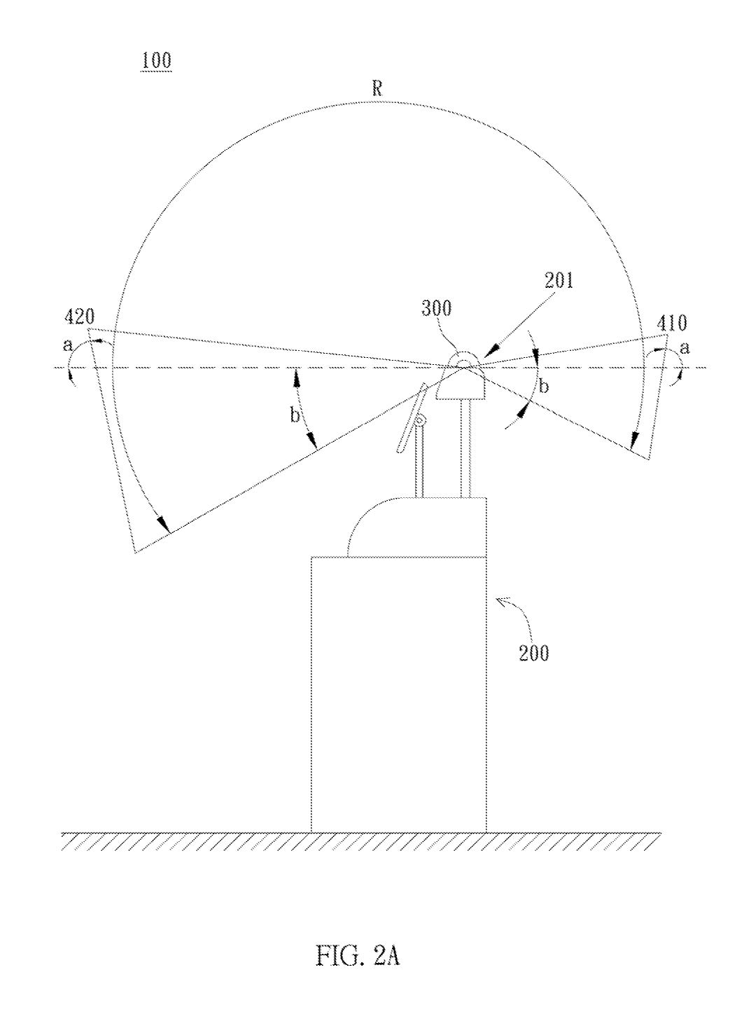

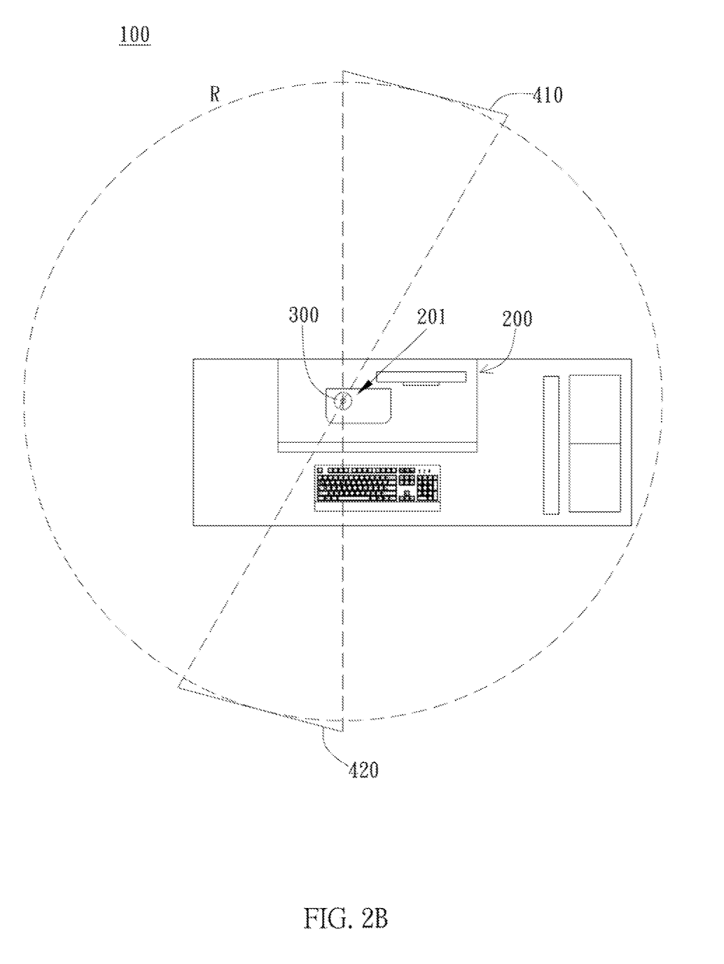

The present invention provides a monitoring device 100, as the monitoring device 100 shown in the side view of FIG. 2A. The monitoring device 100 includes a commercial trading device 200 and a camera device 300. As shown in FIG. 2A, the camera device 300 is disposed on a first position 201 of the commercial trading device 200. The commercial trading device 200 can be a cash register, an auto teller machine (ATM), an online shopping device, or the likes. The camera device 300 has a first view plane 410 formed at one side of the commercial trading device 200, wherein the first view plane 410 is perpendicular to or intersects with the horizontal plane of the first position 201 at an angle (a). With respect to the horizontal plane, the angle (a) is an acute angle larger than or equal to the 45 degrees so as to clearly record the front side of physical characteristics, such as human body. On the other hand, the camera device 300 has a second view plane 420, which is formed at another side of the commercial trading device 200 and opposite to the first view plane 410. Similarly, the second view plane 420 is perpendicular to or intersects with the horizontal plane of the first position 201 at an angle (a), which is an acute angle with respect to the horizontal plane. In addition, a depression angle (b) exists between the horizontal plane of the first position 201 and the first view plane 410 or between the horizontal plane of the first position 201 and the second view plane 420, that is, the depression angle (b) ranges between the horizontal plane and the lowest position of the first view plane 410 or between the horizontal plane and the lowest position of the second view plane 420. Please also refer to the top view of the monitoring device 100 shown in FIG. 2B; the camera device 300 has a viewing range (R) formed by encircling 360 degrees of the first view plane 410 or the second view plane 420 around the camera device 300. In particular, the viewing range (R) includes the first view plane 410, the second view plane 420, and a region between the first view plane 410 and the second view plane 420, wherein the viewing range (R) is larger than 180 degrees. That is, the visual field of the camera device 300 includes the space above the horizontal plane of the first position 201 and the region outwardly extending from the depression angle (b). The camera device 300 may take images in one direction or utilize fisheye lens to obtain a panorama image. The monitoring device 100 utilizes the first view plane 410 or the second view plane 420 to face the front side of physical characteristics so as to avoid image distortions, which results in unrecognizable facial and body features when the viewing angle is too large. For example, the ceiling camera device in prior arts involves problems such as flat viewing angle and obscure features.

When the camera device 300 is disposed on the first position 201 of the commercial trading device 200, the camera device 300 may take images of target objects around the commercial device 200 through the first view plane 410 and the second view plane 420. In order to obtain the relation between the camera device 300 and the target objects, it may consider the resolution of the camera device 300 and ratio of total pixels, as shown in Table 1.

TABLE 1

| | Analog | | | |
|---|---|---|---|---|
| Type | camera D1 | 2 megapixels | 3 megapixels | 5 megapixels |
| Resolution | 720 × 480 | 1,920 × 1,080 | 2,048 × 1,536 | 2,592 × 1,944 |
| Total | 345,600 | 2,073,600 | 3,145,728 | 5,038,848 |
| pixels | | | | |
| ratio of | 1 | 6 | 9.10 | 14.58 |
| total | | | | |
| pixels | | | | |

As shown in Table 1, the number of total pixels is increased by a multiple factor when the camera device 300 having resolution of megapixels is adopted. Because the target object has a width and a length, the square root of the ratio of total pixels can be defined as the magnification, which in each case is √6=2.45, √9=3, √14.58=3.82 that can be rounded to an integral to obtain the magnification of 1, 2, 3, 4. By means of the aforementioned camera devices 300, a specific part of the target object shown in digital magnification will obtain the magnification of 2.45×, 3×, and 3.82× while maintaining the same unit resolution (total pixels/area).

On the other hand, in order to get the effective distance, reference is made to the relation of viewing angle and focal length of the optical lens. Taking ⅓ analog camera lens as example, the relation of focal length and viewing angle is shown in Table 2.

TABLE 2

Focal length

| | 4 mm | 8 mm | 12 mm | 16 mm |
|---|---|---|---|---|
| Viewing angle | 70° | 40° | 30° | 20° |
| magnification | 1x | 2x | 3x | 4x |

It is assumed that the width of the target object is 7 m, the calculations are given as:

(7/2)/tan(70°/2)=3.5/0.700=5.00(viewing distance (m))

(7/2)/tan(40°/2)=3.5/0.363=9.64(viewing distance (m))

(7/2)/tan(30°/2)=3.5/0.267=13.10(viewing distance (m))

(7/2)/tan(20°/2)=3.5/0.176=19.88(viewing distance (m))

That is, if the width of the target object is maintained at 7 m, then the viewing distance increases as the focal length of the optical lens increases. Based on the above calculations, after the magnification of the high resolution camera device 300 is compared with the magnification of the optical lens, the relation of magnification and viewing distance (round up to the integral) of the camera device 300 is shown in Table 3. Based on Table 1 and Table 2, it can be derived that using a high resolution camera device 300 may substitute the zooming method of optical lens to achieve the partial enlargement function, as shown in Table 3.

TABLE 3

| | Analog | | | |
|---|---|---|---|---|
| Type | camera D1 | 2 megapixels | 3 megapixels | 5 megapixels |
| magnification | 1x | 2x | 3x | 4x |
| Viewing distance | 5 | 10 | 13 | 20 |

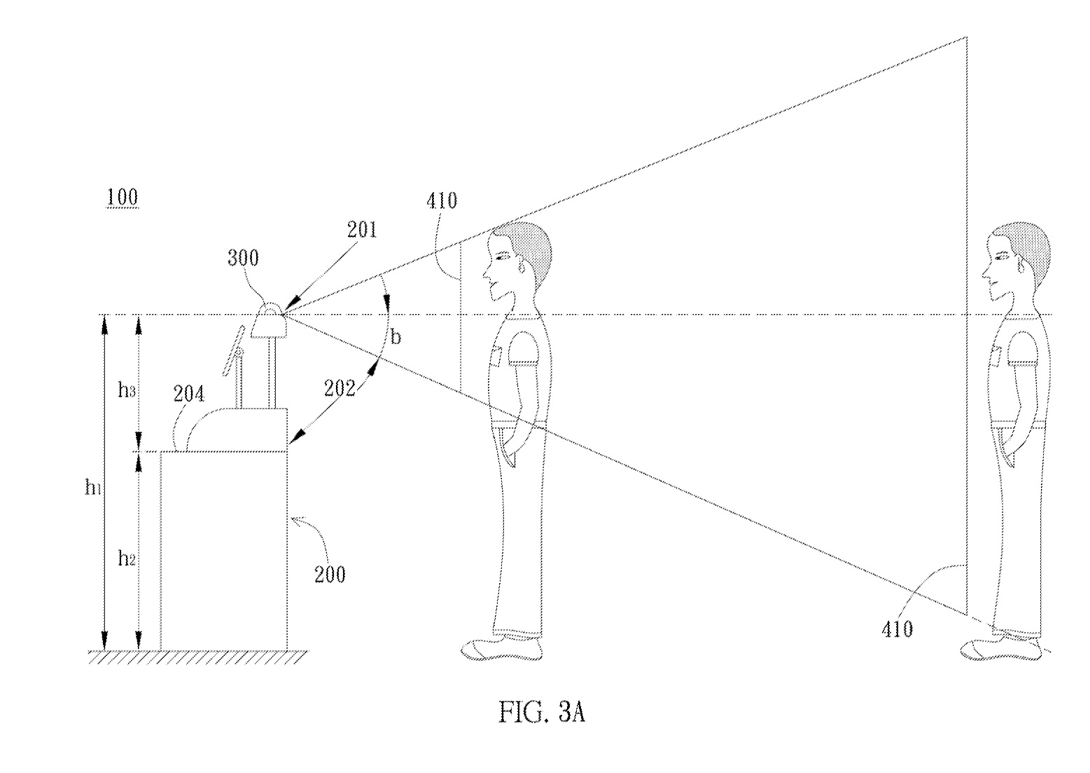

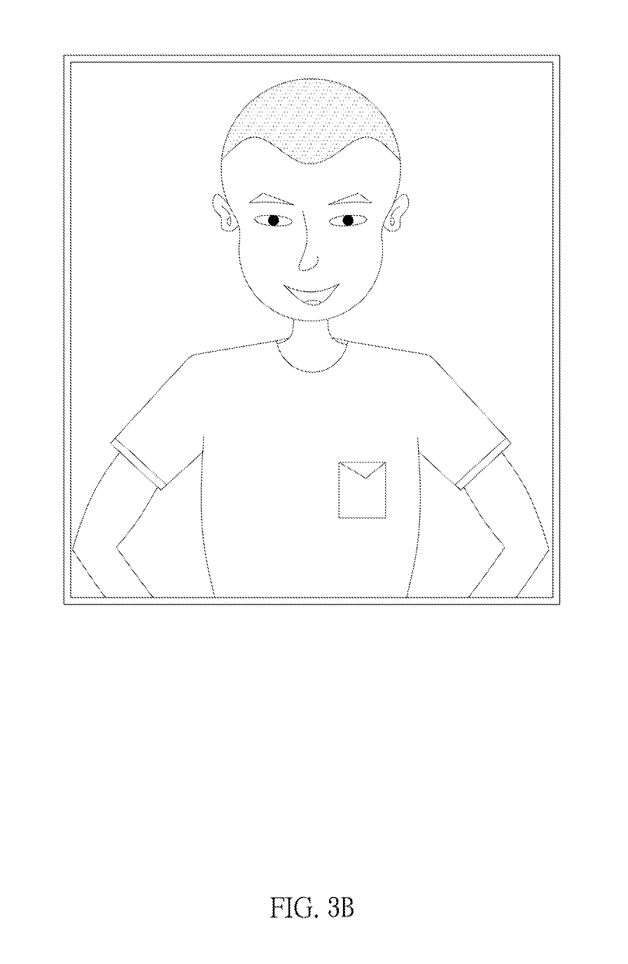

Please refer to FIGS. 3A and 3B. FIG. 3A is a schematic view of an embodiment of the monitoring device of the present invention; FIG. 3B is a schematic view of the image captured by the monitoring device of the present invention. As shown in FIG. 3A, the camera device 300 is disposed on a first position 201 of the commercial trading device 200 and has a height h1 relative to the bottom of the commercial trading device 200, wherein a depression angle (b) exists between the first view plane 410 and the horizontal plane of the first position 201. In addition, the second position 202 of the commercial trading device 200 relative to the bottom of the commercial trading device 200 has a height h2. The height difference between the first position 201 and the second position 202 is a height difference h3 (from a table surface 204 to the horizontal plane of the first position 201). As shown in FIG. 3A, it is assumed that height h1=1.5 m, height h2=1 m, and the depression angle (b) is 17°. Therefore, the height difference h3 is 0.5 m (h3=1.5 m−1 m=0.5 m) and the nearest viewing distances of an upper body and a full body are given as:

tan(90°−17°)×1.5 m=4.90 m;

tan(90°−17°)×0.5 m=1.64 m.

When the camera device 300 is disposed at the first position 201 with a height of 1.5 m, the viewing distance of the upper body is larger than 1.64 m and the viewing distance of the full body is larger than 4.90 m, wherein the captured image of the upper body is corrected as shown in FIG. 3B. The aforementioned depression angle (b) is preferably smaller than 45 degrees to take a clear image and may be adjusted according to the installation position. In other embodiments, the camera device 300 is disposed on an arm extending from the commercial trading device 200. The arm can be a support or a plate for disposing merchandises. The camera device 300 may be connected to the commercial trading device 200 by the arm depending on requirements. Alternatively, the camera device 300 may be embedded into the commercial trading device 200 and disguised with peripheral commodities to prevent the camera device 300 from being destroyed by intentional party.

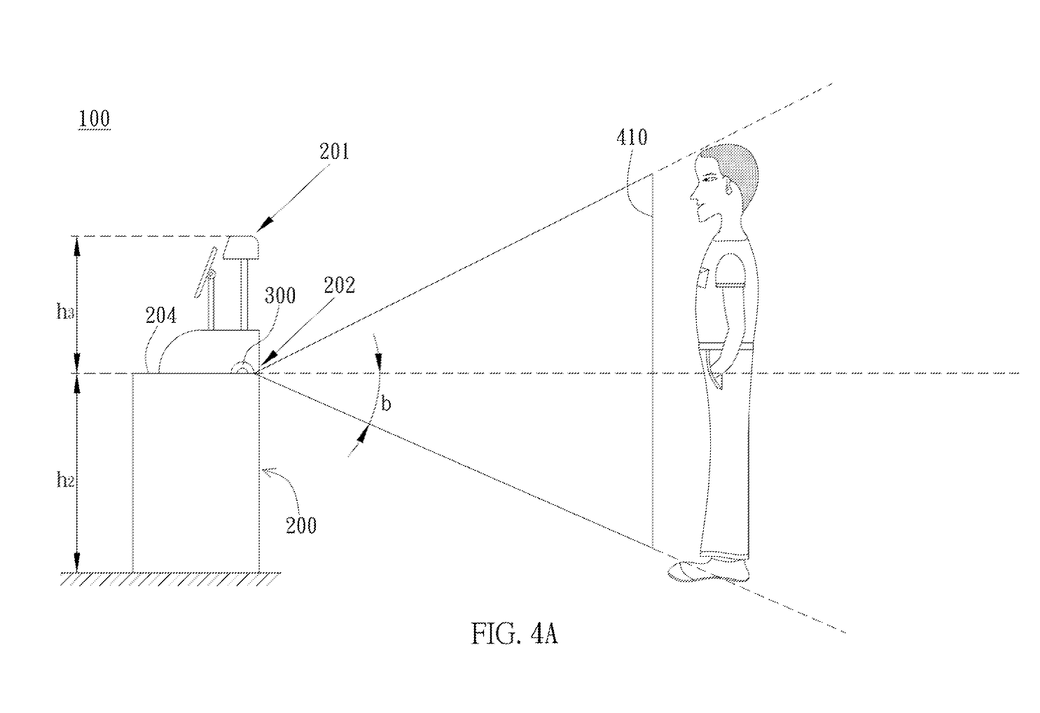

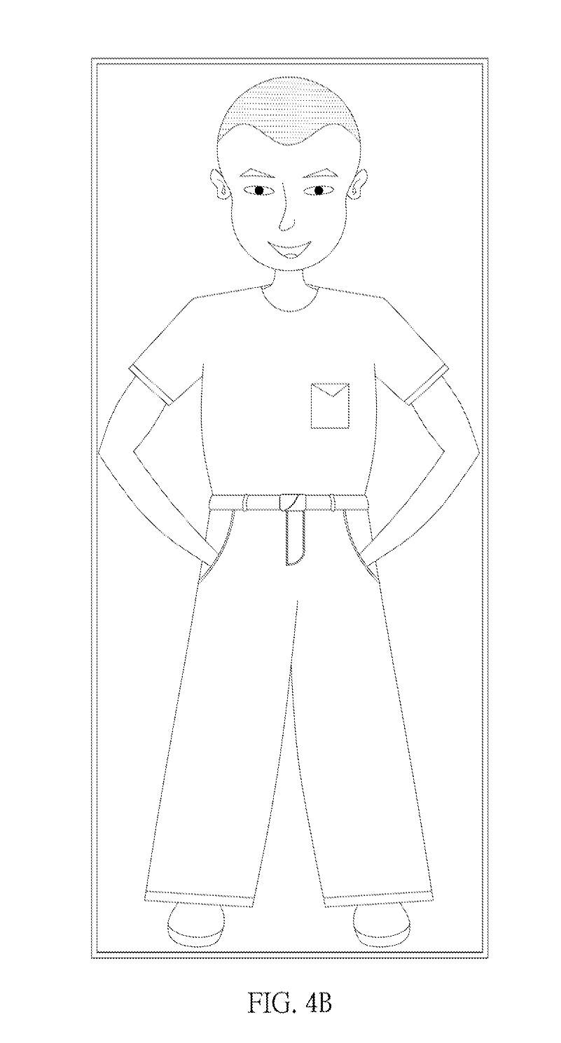

FIG. 4A is a schematic view of another embodiment of the monitoring device of the present invention. FIG. 4B is another schematic view of the image captured by the monitoring device of the present invention. As shown in FIG. 4A, the camera device 300 is disposed on the second position 202 in the vicinity of the commercial trading device 200 and has the height h2, i.e. from the bottom of the commercial trading device 200 to the table surface 204, wherein a depression angle (b) exists between the first view plane 410 and the horizontal plane of the second position 202. In addition, the commercial trading device 200 has a height h1. As shown in FIG. 4A, the first position 201 and the second position 202 have a height difference h3, i.e. from the table surface 204 to the horizontal plane of the first position 201. As shown in FIG. 4A, it is assumed that height difference h3=0.5 m, height h2=1 m, and the depression angle (b) is 17°. Therefore, the nearest viewing distance of an lower body is given as:

tan(90°−17°)×1 m=3.27 m.

When the camera device 300 is disposed at the second position 202 with a height of 1 m, the viewing distance of the lower body is larger than 3.27 m, wherein the captured image of the lower body is corrected as shown in FIG. 4B. In addition, the viewing range extending from the camera device 300 may be adjusted according to the height of the camera device 300. For example, the camera device 300 can be disposed at the height between the first position 201 and the second position 202. In the embodiment mentioned above, the height difference h3 of the commercial device 200 is the height difference between the first position 201 and the second position 202, but is not limited thereto. The second position 202 and the height difference h3 of the commercial trading device 200 may be other suitable reference point depending on requirement. Taking the aforementioned data as example, the first position 201 and the second position 202 has the height difference h3=0.5 m which is a preferred range to dispose the camera device 300. In order to get a clear image that is not blocked by the height, the camera device 300 may be disposed at a height up to 1 m higher than the table surface 204. Besides, the position and the quantity of the camera device 300 may be distributed between the first position 201 and the second position 202 depending on requirements. The camera device 300 of the present invention is preferably disposed at the height up to 2 m measured from the bottom of the commercial trading device 200 (i.e. from the ground) and the depression angle (b) is preferably smaller than 45 degrees which can be adjusted corresponding to the installation position to take a clear image.

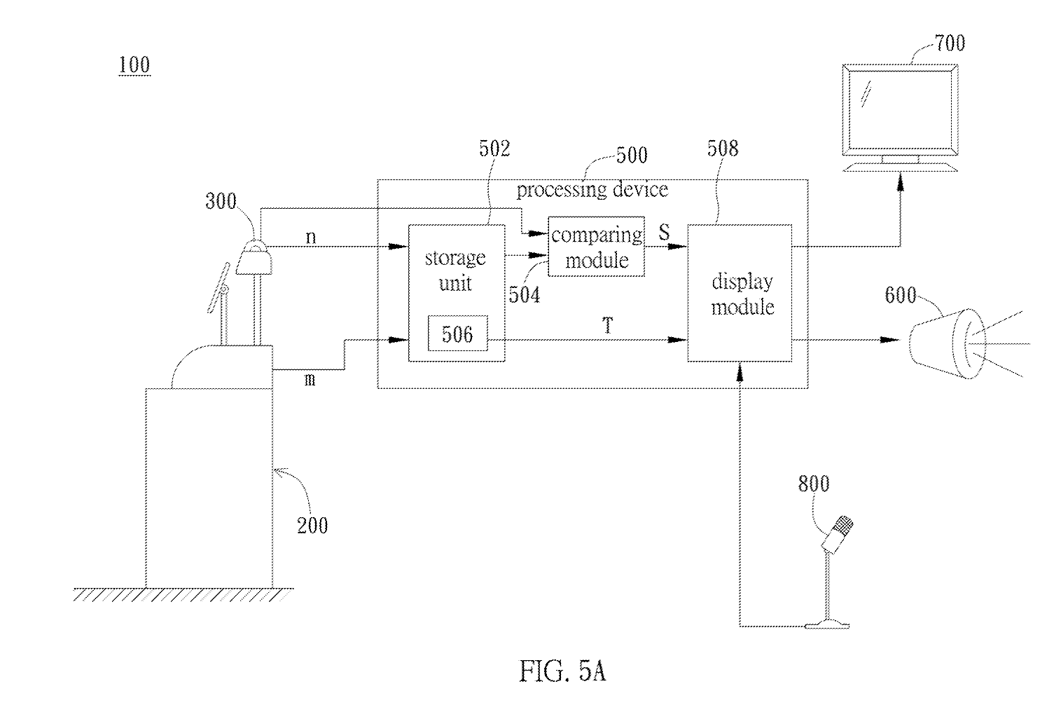

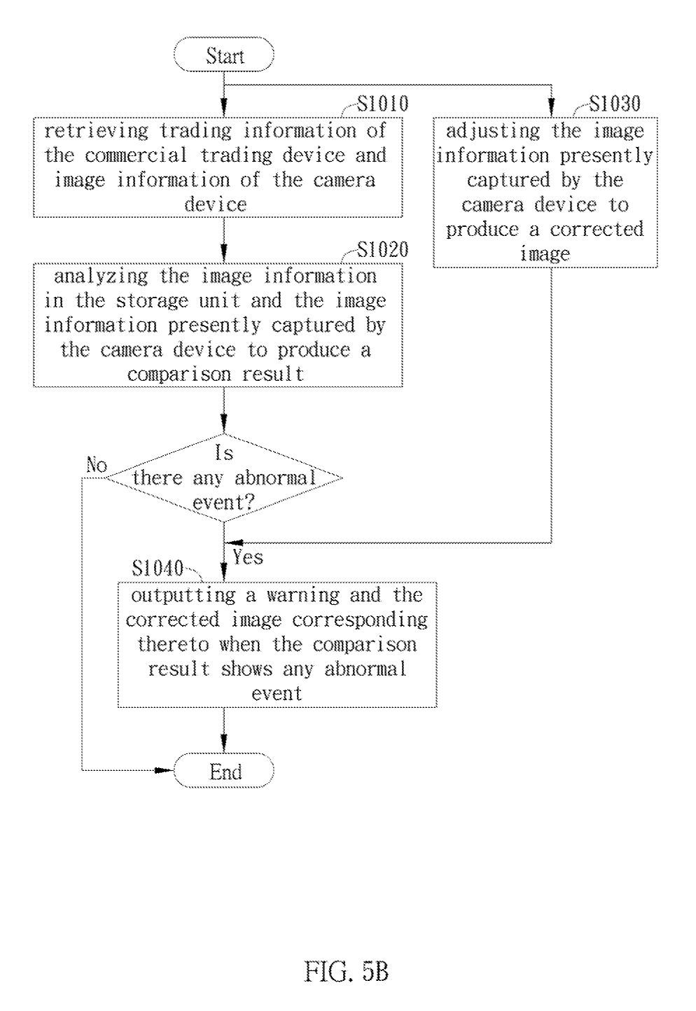

FIG. 5A is a schematic view of the monitoring device of the present invention. As shown in FIG. 5A, the monitoring device 100 further has a processing device 500 connecting the commercial trading device 200 and the camera device 300. The processing device 500 includes a storage unit 502, a comparing module 504, a correction module 506, and a display module 508. The storage unit 502 retrieves trading information (m) and image information (n) of the camera device 300. The comparing module 504 obtains the image information (n) from the storage unit 502 and analyzes the image information (n) to produce a comparison result (S). For example, the storage unit 502 can have particular preset information such as figure, clothing, environment, etc. which is to be compared with the image information (n) of the camera device 300. The correction module 506 obtains the image information (n) presently captured by the camera device 300 and adjusts the image information (n). The display module 508 receives the comparison result (S) and the corrected image (T). When the comparison result (S) shows an abnormal event, the display module 508 receives a corrected image (T) from the correction module 506 and then outputs the corrected image (T) to a display device 700 and a warning is outputted by an alarm 600 or by the display module 508 corresponding to an external audio signal from the microphone 800. In other embodiments, the display device 700 may directly search the comparison result (S) and the corrected image (T) in the display module 508 based on time, warning events, or trading information (m) and present the corrected image (T) by split-screens, scale down frames, scale up frames, rotating frames, or playback the specific image on demand. In addition, the processing device 500 may record trading information (m) and image information (n) by wire or wireless method. The processing device 500 may be disposed apart from the commercial trading device 200 to ensure data from being destroyed by potential criminals.

The practical workflow mentioned above is shown in FIG. 5B. The monitoring method includes step S1010: retrieving trading information of the commercial trading device and image information of the camera device. The storage unit retrieves trading information of the commercial trading device and image information of the camera device and then outputs them to the comparing module. Step S1020 involves analyzing the image information in the storage unit and the image information presently captured by the camera device to produce a comparison result. The storage unit can have particular preset information such as figure, clothing, environment, etc. which is to be compared with the image information of the camera device. Step S1030 involves adjusting the image information presently captured by the camera device to produce a corrected image. If comparing result shows the image information in the storage unit and the image information presently captured by the camera device relating to an abnormal event, the display module receives the comparison result and the corrected image. Step S1040 involves outputting a warning and the corrected image corresponding thereto when the comparison result shows any abnormal event. Step S1042 involves the display module receiving an external audio signal and outputs a warning.

With the monitoring device 100 of the present invention, the pictures may be corrected by digital computing software and be presented in various split-screens. People having bad intention may be detected and abnormal events may be outputted by analysis technology of physical characters or color of clothing, and audio identifying software can be further incorporated to output a warning by shouting a key word, instead of manually pressing a button. The encircling recording image of the monitoring device 100 of the present invention is suitable for image analysis technology to detect physical characters, clothing and can assist in informing of abnormal invasion of the cash desk when the staff leaves the cash desk.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A monitoring device, comprising:
a commercial trading device having a first position; and
at least a camera device disposed on the first position of the commercial trading device, the camera device having a first view plane formed at one side of the commercial trading device; wherein the first view plane intersects with a horizontal plane of the first position at a right angle or an acute angle.

2. The monitoring device of claim 1, wherein the camera device has a second view plane formed at the other side of the commercial trading device opposite to the first view plane, the second view plane intersects with the horizontal plane of the first position at a right angle or an acute angle, wherein the camera device has a viewing range including the first view plane, the second view plane, and a region between the first view plane and the second view plane, wherein the viewing range is larger than 180 degrees and the acute angle is equal to or larger than 45 degrees.

3. The monitoring device of claim 2, wherein the viewing range is formed by encircling 360 degrees of the first view plane or the second view plane around the camera device.

4. The monitoring device of claim 2, wherein a depression angle smaller than 45 degrees exists between the horizontal plane of the first position and the lowest position of the first view plane or between the horizontal plane of the first position and the lowest position of the second view plane.

5. The monitoring device of claim 1, wherein the height from the bottom of the commercial trading device to the first position is less than 2 meters.

6. The monitoring device of claim 1, further comprising an arm extending from the commercial trading device to connect the camera device with the commercial trading device.

7. The monitoring device of claim 1, further comprising a processing device connecting the commercial trading device and the camera device, the processing device comprising a storage unit retrieving trading information of the commercial trading device and image information of the camera device.

8. The monitoring device of claim 7, wherein the processing device further comprises a comparing module obtaining the image information from the storage unit and analyzing the image information to produce a comparison result.

9. The monitoring device of claim 7, wherein the processing device further comprises a correction module obtaining the image information from the storage unit and adjusting the image information to produce a corrected image.

10. A monitoring device, comprising:
a commercial trading device; and
at least a camera device disposed on a second position, the second position having a height difference relative to the commercial trading device, the camera device having a first view plane formed at one side of the commercial trading device; wherein the first view plane intersects with the horizontal plane of the first position at a right angle or an acute angle.

11. The monitoring device of claim 10, wherein the camera device has a second view plane formed at the other side of the commercial trading device opposite to the first view plane, the second view plane intersects with the horizontal plane of the first position at a right angle or an acute angle, wherein the camera device has a viewing range including the first view plane, the second view plane, and a region between the first view plane and the second view plane, wherein the viewing range is larger than 180 degrees and the acute angle is equal to or larger than 45 degrees.

12. The monitoring device of claim 11, wherein the viewing range is formed by encircling 360 degrees of the first view plane or the second view plane around the camera device.

13. The monitoring device of claim 11, wherein a depression angle smaller than 45 degrees exists between the horizontal plane of the first position and the lowest position of the first view plane or between the horizontal plane of the first position and the lowest position of the second view plane.

14. The monitoring device of claim 10, wherein the height from the bottom of the commercial trading device to the first position is less than or equal to 2 meters.

15. The monitoring device of claim 10, further comprising a processing device connecting the commercial trading device and the camera device, the processing device comprising a storage unit retrieving trading information and image information of the camera device.

16. The monitoring device of claim 15, wherein the processing device further comprises a comparing module obtaining the image information from the storage unit and analyzing the image information to produce a comparison result.

17. The monitoring device of claim 15, wherein the processing device further comprises a correction module obtaining the image information from the storage unit and adjusting the image information to produce a corrected image.

18. A monitoring method utilized in the monitoring device of claim 1, comprising:
retrieving trading information of the commercial trading device and image information of the camera device by a processing device;
analyzing the image information in the storage unit and the image information presently captured by the camera device to produce a comparison result; and
adjusting the image information presently captured by the camera device to produce a corrected image.

19. The monitoring method of claim 18, further comprising:
receiving the comparison result and the corrected image by a display module; and
when the comparison result shows an abnormal event, the display module outputting the corrected image and a warning.

20. The monitoring method of claim 19, wherein the display step comprises:
receiving an external audio signal and outputting a warning by the display module.
